(19) United States
(12) Patent Application Publication
(10) Pub. No.: US 2018/0027199 A1
(43) Pub. Date: Jan. 25, 2018

(54) IMAGE PROCESSING APPARATUS, IMAGE CAPTURE APPARATUS, AND METHOD FOR CONTROLLING THE SAME

(71) Applicant: CANON KABUSHIKI KAISHA, Tokyo (JP)

(72) Inventor: Toshiyuki Okubo, Machida-shi (JP)

(21) Appl. No.: 15/643,511

(22) Filed: Jul. 7, 2017

(30) Foreign Application Priority Data
Jul. 22, 2016 (JP) 2016-144405

(51) Int. Cl. H04N 5/367; H04N 5/232; H04N 5/361

(52) U.S. Cl. CPC H04N 5/3675; H04N 5/361; H04N 5/23229

(57) ABSTRACT

An image capture apparatus serving as an image processing apparatus generates a combined image by combining a plurality of captured images. The image capture apparatus determines a pixel of interest among the captured images as a correction target pixel if a difference between a signal level of the pixel of interest and that of the peripheral pixels is greater than or equal to a threshold. The image capture apparatus performs the above determination with respect to the captured image prior to the combination by using a first threshold, and performs the above determination with respect to the combined image by using a second threshold lower than the first threshold, and sets the second threshold with respect to the combined image lower the larger the number of the combined captured images is.

### BACKGROUND OF THE INVENTION

### Field of the Invention

The present invention relates to an image processing apparatus and a method for controlling the same.

### Description of the Related Art

Image capture apparatuses such as home video cameras and digital still cameras generally provide functions such as continuous shooting or moving images, which improve the convenience of shooting for users. While these image capture apparatuses improve sensitivity for an imaging element and realize obtaining high image quality, in a dark place, some noticeable noise may be caused, and thus, there is a demand for the more sensitivity.

Japanese Patent Laid-Open No. 2012-165479 discloses an image processing apparatus that realizes noise reduction by shooting a plurality of images and performing addition averaging. Also, Japanese Patent Laid-Open No. 2008-301481 discloses an image processing apparatus that detects and corrects a defective pixel from the captured image without shooting a black image.

If the imaging element includes a defective pixel whose dark current is different from a normal one, the shooting with high sensitivity, lengthy time, or high temperature may be significantly sensitive to the influence of the dark current, thereby causing the reduction of the image quality. To resolve such a defective pixel, the defective pixel is examined at the time of manufacture, and the coordinate of the defective pixel is previously stored to correct such a defect when shooting the image. However, this method cannot solve all of the defective pixels which have not been examined at the time of manufacture and that are generated after the manufacture.

Also, there is a pixel that does not always output the dark current among of the defective pixel of the imaging element. The defective pixel referred to as an RTS noise flaw has a property of an unequable output of the dark current and of output level of the dark current fluctuating every reading. The conventional image processing apparatuses cannot properly detect and correct the defective pixel since the defective pixel is detected in the state in which the noise is not acceptable. Also, if the defective pixel is intended to be corrected after combining the captured images, it becomes difficult to detect a flaw that does not always occur every shooting, such as the RTS noise flaw, since such a flaw decreases its level due to the addition averaging at the combination.

### SUMMARY OF THE INVENTION

The present invention provides an image processing apparatus capable of correctly detecting a defective pixel during shooting by combining captured images.

The image processing apparatus according to one embodiment of the present invention comprises: circuitry which combines a plurality of captured images by shooting an object to generate a combined image; and determines a pixel of interest on the captured images as a correction target pixel if a difference between a signal level of the pixel of interest and a value obtained from the signal level of the peripheral pixel of interest is greater than or equal to a threshold. The circuitry performs the determination with respect to the captured image prior to the combination by using a first threshold, and performs the determination with respect to the combined image by using a second threshold lower than the first threshold, and the larger the number of the combined captured images is, sets the second threshold with respect to the combined image to be lower.

Further features of the present invention will become apparent from the following description of exemplary embodiments with reference to the attached drawings.

### BRIEF DESCRIPTION OF THE DRAWINGS

FIG. 1 illustrates an exemplary configuration of an image processing apparatus according to the present embodiment.

FIG. 2 illustrates processing in a shooting mode with noise reduction.

FIG. 3 illustrates generation processing of a combined image.

FIG. 4 illustrates flaw correction processing.

FIG. 5 illustrates defective pixel detection processing.

FIG. 6 illustrates an exemplary threshold for flaw detection depending on imaging sensitivity.

FIG. 7 illustrates an exemplary threshold for flaw correction depending on shutter time.

FIG. 8 illustrates the threshold for flaw detection depending on the number of the combined captured images.

### DESCRIPTION OF THE EMBODIMENTS

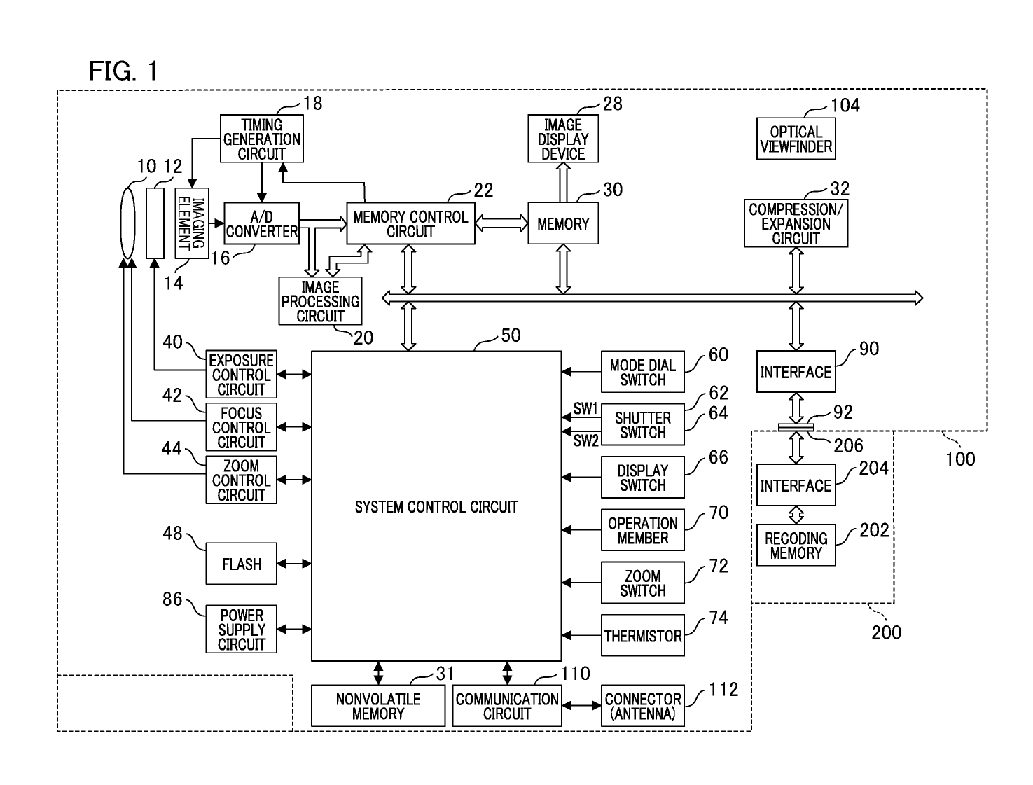

FIG. 1 illustrates an exemplary configuration of an image processing apparatus according to the present embodiment. In the present embodiment, a description will be given using an image capture apparatus 100, which is a digital camera, as an exemplary image processing apparatus. a shooting lens 10 denotes a shooting lens, a shutter 12 denotes a shutter having an aperture function, an imaging element 14 denotes an imaging element that converts an optical image into an electrical signal, and an A/D converter 16 denotes an A/D converter that converts an analog signal output of the imaging element 14 into a digital signal.

A timing generation circuit 18 denotes a timing generation circuit that supplies a clock signal and a control signal to the imaging element 14 and the A/D converter 16. The timing generation circuit 18 is controlled by a memory control circuit 22 and a system control circuit 50. The shutter 12 may be a mechanical shutter, or an electronic shutter used by controlling a reset timing of the imaging element 14.

An image processing circuit 20 denotes an image processing circuit. The image processing circuit 20 performs predetermined pixel interpolation processing and color conversion processing on data from the A/D converter 16 or data from the memory control circuit 22. An electronic zoom function is accomplished by the image clipping and resizing processing in the image processing circuit 20. Also, the image processing circuit 20 performs predetermined calculation processing using the shoot image data (captured image).

A system control circuit 50 denotes a system control circuit that controls the image capture apparatus 100 overall. The system control circuit 50 and the imaging element 14 function as a shooting unit configured to shoot an object and output the captured image. Also, the system control circuit 50 functions as a combining unit configured to combine a plurality of captured images to generate a combined image. Also, the system control circuit 50 performs AF processing, AE processing, and EF processing of the TTL method by controlling an exposure control circuit 40 and a focus control circuit 42 based on the calculation result obtained by the image processing circuit 20. Also, the system control circuit 50 performs auto white balance (AWB) processing of the through the lens (TTL) method based on the calculation result obtained by the image processing circuit 20.

A memory control circuit 22 denotes a memory control circuit. The memory control circuit 22 controls the A/D converter 16, the timing generation circuit 18, the image processing circuit 20, a memory 30, and a compression/expansion circuit 32. The output data from the A/D converter 16 is written into the memory 30 via the image processing circuit 20 and the memory control circuit 22, or it is written into the memory 30 directly via the memory control circuit 22

An image display device 28 denotes an image display device having a thin film transistor (TFT), a liquid crystal display (LCD), and the like. The image data for display written into the memory 30 is displayed on the image display device 28 via the memory control circuit 22. If the captured image is consecutively displayed by using the image display device 28, it is possible to implement an electronic finder function. Furthermore, the image display device 28 can arbitrarily turn on/off the display according to an instruction from the system control circuit 50. If the display is turned off, power consumption in the image capture apparatus 100 can be reduced considerably.

A memory 30 denotes a memory which stores captured still images and captured moving images. The memory 30 has a storage capacity enough to store a predetermined number of the still images and a predetermined amount of time of the moving images. Thereby, in a case of continuous shooting, in which a plurality of still images is shot continuously, or panorama shooting, it is possible to write a large number of images into the memory 30 at high speed. Furthermore, the memory 30 can be used as a working area of the system control circuit 50.

A nonvolatile memory 31 denotes a nonvolatile memory with a flash ROM. A program code to be executed by the system control circuit 50 is written into the nonvolatile memory 31. While reading the program code consecutively, the system control circuit 50 executes the program code. Furthermore, an area configured to store system information and an area configured to store user setting information are provided in the nonvolatile memory 31 so that various kinds of information and setting can be read and reconstructed the next time the apparatus is activated.

A compression/expansion circuit 32 denotes a compression/expansion circuit that compresses/expands image data by an adaptive discrete cosine transform (ADCT) or the like. The compression/expansion circuit reads an image stored in the memory 30, performs compression processing or expansion processing, and writes the processed data into the memory 30. An exposure control circuit 40 denotes an exposure control circuit that controls the shutter 12. The exposure control circuit 40 also has a flash dimmer function through cooperation with a flash 48.

A focus control circuit 42 denotes a focus control circuit that controls the focusing of the shooting lens 10. A zoom control circuit 44 denotes a zoom control circuit that controls the zooming of the shooting lens 10. A flash 48 denotes a flash. The flash 48 has AF-auxiliary-light projector function and flash dimmer function. Switches/operating members 60, 62, 64, 66, 70, and 72 denote switches/operating members for inputting various operational instructions into the system control circuit 50 by the user. The switches/operating members are configured by one or a combination of switches, dials, a touch panel, a pointing device that uses vision detection, a voice recognition device, and the like. Hereinafter, a detailed description will be given of the switches/operating members.

A mode dial switch 60 denotes a mode dial switch. The mode dial switch 60 can switch between functional modes, such as power off, an automatic shooting mode, a shooting mode, a panoramic shooting mode, a moving image shooting mode, a replay mode, and a PC connection mode. A shutter switch 62 denotes a shutter switch SW1. The SW1 is turned on when a shutter button is pressed partway in order to provide instructions to start operations such as AF (autofocus) processing, AE (auto-exposure) processing, and AWB (auto white balance) processing, by the system control circuit 50.

A shutter switch 64 denotes a shutter switch SW2. The SW2 is tuned on when the above shutter button is pressed fully. After the SW2 is tuned on, in a case of performing flash shooting, the system control circuit 50 performs EF (flash pre-emission) processing and then exposures the imaging element 14 for the exposure time determined by AE processing.

The system control circuit 50 finishes the exposure on the imaging element 14 by shielding against light with the exposure control circuit 40 at the same time as the end of the exposure period. Subsequently, the system control circuit 50 instructs an operational start for read processing in which a signal read from the imaging element 14 is written as the image data into the memory 30 via the A/D converter 16 and the memory control circuit 22, and development processing using calculations performed by the image processing circuit 20 and the memory control circuit 22. Also, the system control circuit 50 executes recording processing in which the image data is read from the memory 30, compressed by the compression/expansion circuit 32, and written into the recording medium 200. As the function characteristic of the present embodiment, the system control circuit 50 executes the noise reduction and the correcting processing of the flaw with respect to the captured image if the shooting mode is set as the shooting mode with noise reduction.

A display switch 66 denotes a display switch. By operating the display switch 66, the display of the image display device 28 can be switched. This function can reduce power consumption by blocking the power supply to the image display device 28 consisting of TFT LCD or the like when shooting with an optical viewfinder 104.

An operation member 70 denotes an operation member with various buttons, a touch panel, a rotary dial and the like. The operation member 70 includes, for example, a menu button; a set button; a macro button, a multi-screen reproduction page-advance button, a flash device set button, a single shooting/continuous shooting/self-timer switch button and the like. Also, the operation member 70 includes, for example, a menu shift+(plus) button; a menu shift−(minus) button, a reproduction image shift+(plus) button, a reproduction image shift−(minus) button, an image-quality selection button, an exposure correction button, a date and time set button, and the like.

A zoom switch 72 denotes a zoom switch with which the user issues an instruction to change the magnification of a captured image. The zoom switch 72 includes a telephoto switch that changes the capturing field angle toward the telephoto side and a wide-angle switch that changes the capturing field angle toward the wide-angle side. Operating the zoom switch 72 will issue an instruction to the zoom control circuit 44 to change the capturing field angle of the shooting lens 10, thereby providing a trigger to perform optical zoom operation. The operation of the zoom switch 72 also provides a trigger to make the image processing circuit 20 perform image clipping and a trigger to perform the electronic zoom changing operation for the capturing field angle by image interpolation processing or the like.

A thermistor 74 denotes a thermistor which measures temperature inside the camera. Since the defective pixel of the imaging element is sensitive to the temperature, it is necessary to change the flaw correction processing depending on the temperature at the shooting. The thermistor 74 is placed close to the imaging element 14 in the image capture apparatus, and measures the temperature of the imaging element 14 itself. A power supply circuit 86 denotes a power supply circuit configured of, for example, primary batteries such as alkaline batteries; secondary batteries such as NiCd batteries, NiMH batteries, and Li-ion batteries; and an AC adapter and the like.

An interface 90 denotes an interface with the recording medium such as a memory card or hard disk. A connector 92 denotes a connector that connects the apparatus to the recording medium such as the memory card or hard disk. An optical viewfinder 104 denotes an optical viewfinder. It is possible to shoot an image by using only the optical viewfinder 104 without using the electronic viewfinder function of the image display device 28. A communication circuit 110 denotes a communication circuit having various communication functions such as USB, IEEE1394, LAN, and Wireless communication.

A connector 112 denotes a connector that connects the image capture apparatus 100 to another device via the communication circuit 110. The connector 112 denotes an antenna for wireless-communication. A recording medium 200 denotes a recording medium such as a memory card or hard disk. The recording medium 200 comprises a recoding memory 202 such as a semiconductor memory or magnetic disk, an interface 204 that interfaces with the image capturing apparatus 100, and a connector 206 that makes connections to the image capture apparatus 100.

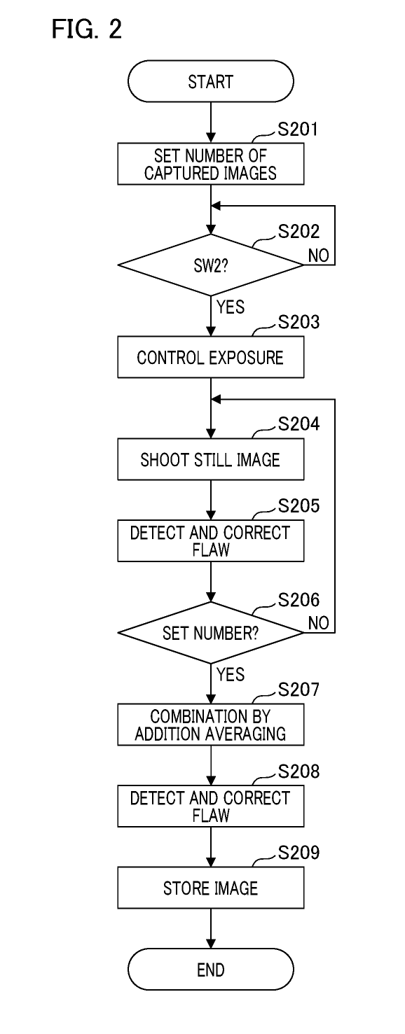

FIG. 2 is a flowchart illustrating exemplary processing at a shooting mode with noise reduction.

If the shooting mode with noise reduction is set, in S201, the system control circuit 50 sets the number of the captured images depending on the operation with the operation member 70 by the user. The larger the number of the combined images is, the higher the effect of the noise reduction on the random noise is. In general, the effect of the noise reduction by combining the four images corresponds to one stage of the noise reduction.

Next, in S202, the system control circuit 50 determines whether or not the SW2 has been pressed. If the SW2 has not been pressed, the processing returns to S202. If the SW2 has been pressed, the processing proceeds to S203. In S203, the system control circuit 50 stars the shooting and controls the exposure. With respect to the shutter speed, the aperture value, and the sensitivity in the shooting, the set values previously determined by the automatic exposure control or the set values that are optionally instructed by the user is used.

In S204, the system control circuit 50 shoots a still image. The still image as one image is the image before the S/N becomes better, since the noise reduction by combining the images is not performed with respect to the image as one image. In S205, the system control circuit 50 detects and corrects the flaw in the still image. Since the detection for flaws detects the flaws with respect to the image whose S/N is not better, it is difficult to distinguish between the noise and the flaw in such an image. Thus, the system control circuit 50 sets a threshold to detect only a large flaw. The detail description of the setting the threshold is described hereinafter.

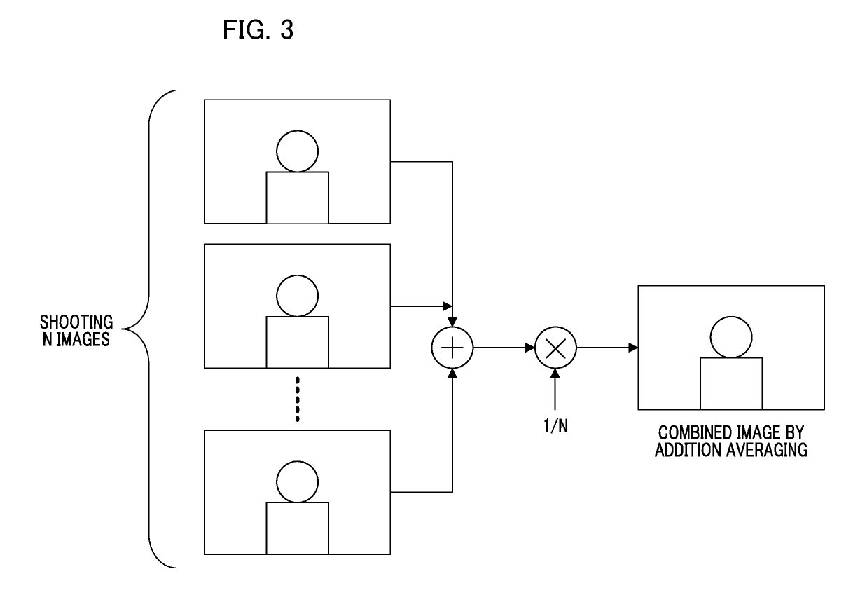

In S206, the system control circuit 50 determines whether or not the shooting number of the images set in S201 has completed. If the shooting has not completed, the processing returns to S204. If the shooting has completed, the processing proceeds to S207. In S207, the system control circuit 50 performs the processing of the addition averaging. Thereby, the noise reduction is performed. The processing of the addition averaging is described hereinafter by using FIG. 3.

Next, in S208, the system control circuit 50 performs the detection and correction for a flaw in the combined image generated by the addition averaging. In the combined image generated by the addition averaging, S/N becomes better, and thereby, a small flaw can be detected. Accordingly, the system control circuit 50 sets a threshold by which the small flaw can be detected. In S209, the system control circuit 50 records the combined image into the recording medium 200.

FIG. 3 illustrates generation processing of the combined image.

The image capture apparatus 100 stores all of the captured images (all images) into the memory 30, and then, sequentially adds the all images at the completion of the shooting. In this example, the image capture apparatus 100 simply adds the images to each other. The image capture apparatus 100 performs gain processing as 1/N with respect to the added images, if N images are added. Thereby, the brightness of the image is returned and the random noise is suppressed, which obtains the effect of the noise reduction. While in a shooting flow illustrated by referring to FIG. 2, the shooting is performed followed by the processing of the addition averaging for the captured image, the processing of the addition may be performed sequentially at the shooting. Thereby, there is no need to ensure the memory for the number of the captured images.

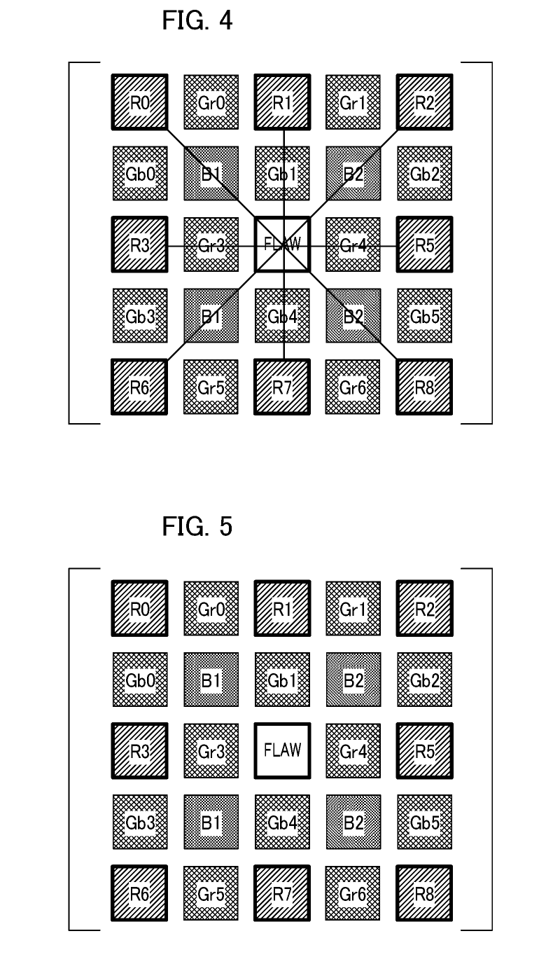

FIG. 4 illustrates flaw correction processing executed by the image capture apparatus.

A pixel referred to as the “flaw” in the middle of FIG. 4 is explained as the target of the correction for flaw. Since the target pixel with respect to the correction of a flaw is a pixel of a color filter “R” (R pixel), the system control circuit 50 corrects the flaw by using the surrounding R pixels.

Firstly, the system control circuit 50 acquires a level difference between the pixels respectively disposed at the diagonal and opposite positions (Diff).
Diff1=|R0−R8|

Diff2=|R1−R7|

Diff3=|R2−R6|

Diff4=|R3−R5|

The system control circuit 50 searches for the minimum value among Diff1 to Diff4. The minimum of the level difference means that there is no edge portion between the pixels, and the correction by the pixel interpolation is adequate in such a level difference. Thereby the system control circuit 50 acquires the average value by using a combination for which the level difference is minimum, and sets it as a flaw correction pixel. For example, if Diff1 is minimum, the system control circuit 50 acquires a correction value PixCorrect by using the following calculation:

PixCorrect=(R0+R8)/2.

This calculation is performed on all of the target pixels, and by using the correction values, the correction for a flaw is performed by the interpolation from the peripheral pixel of interest. While the average value of the level difference by direction based on the target pixel is employed as the correction value in the present embodiment, the average value for all of the peripheral pixels may be used. Also, all of the level differences by direction less than or equal to the predetermined value may be used to set the average value as the correction value.

FIG. 5 illustrates defective pixel detection processing by the image capture apparatus.

The system control circuit 50 determines whether or not the target pixel (pixel of interest) significantly deviates from the average level of the peripheral pixels with the same color as that in detecting the defective pixel (detecting the flaw). If the R pixel referred to as the “flaw” in the middle of FIG. 5 is the target pixel for detecting the defective pixel, the system control circuit 50 acquires the maximum value PixMax and the minimum value PixMin among peripheral R0 to R8.

The system control circuit 50 determines whether or not the difference MaxMinDiff between PixMax and PixMin is less than or equal to a predetermined value. MaxMinDiff being less than or equal to the predetermined value means that there is no edge portion in the area of the target pixel. Therefore, the defective pixel is determined with respect to the target pixel. If thedifference PixDiff between the average value PixAve among R0 to R8 and the target pixel PixTarget is more than or equal to the predetermined threshold, the system control circuit 50 determines the target pixel to be the defective pixel (correction target pixel). In other words, the system control circuit 50 functions as a determining unit configured to determine whether or not the pixel of interest is set as the correction target pixel depending on the result of comparing the difference between the signal level for the pixel of interest and the value obtained from the signal level of the peripheral pixelsin the captured images, with the detection threshold. According to the present embodiment, the system control circuit 50 performs the above determination with respect to the captured image prior to the combination by using a first detection threshold, and with respect to the combined image by using a second detection threshold different from the first detection threshold. According to the present embodiment, the system control circuit 50 sets the second detection threshold to be lower than the first detection threshold.

While whether or not the target pixel is a defective pixel is determined by comparing the signal level for the pixel of interest and the value obtained from the signal level of the peripheral pixels in the captured images, with the detection threshold according to the present embodiment, the level difference by direction may be acquired to set the average value of the level of the pixels in a direction in which the level difference is small as the target of comparison.

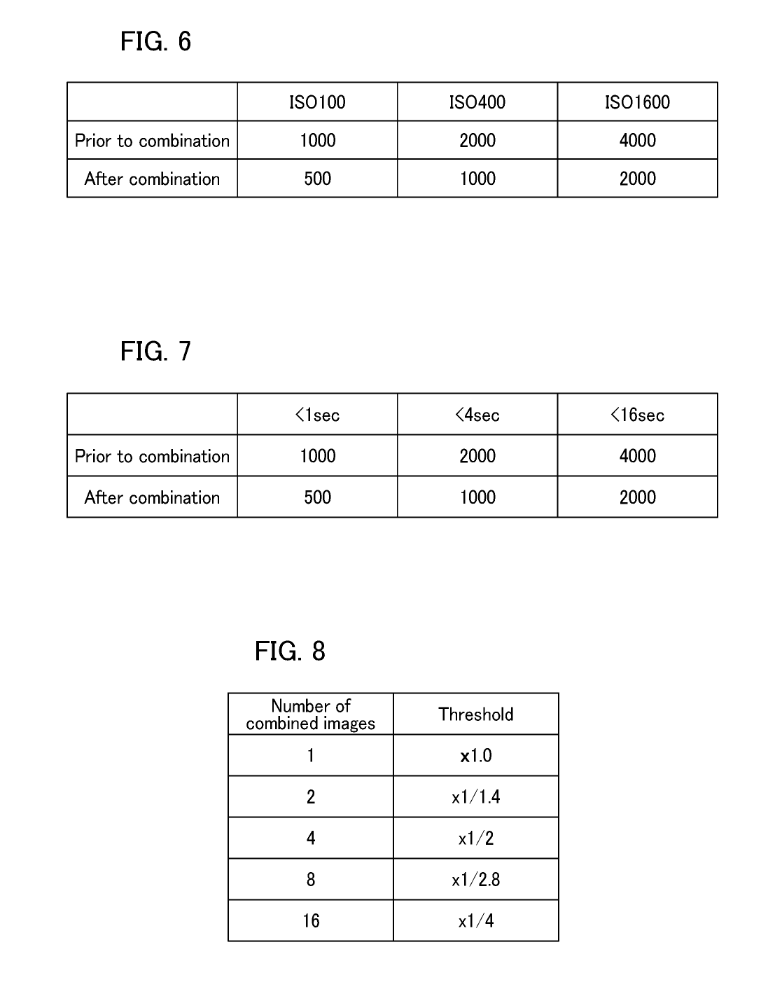

The system control circuit 50 may alter the first detection threshold and the second detection threshold depending on the shooting condition in capturing the object. Hereinafter, a description will be given of examples of setting the threshold for flaw detection depending on the imaging sensitivity and the shutter time among of the shooting condition, referring to FIG. 6 and FIG. 7 respectively.

FIG. 6 illustrates the example of the threshold for flaw detection depending on the imaging sensitivity.

In FIG. 6, an exemplary description will be given by using an ISO sensitivity as the imaging sensitivity. As shown in FIG. 6, as both of the thresholds for flaw detection with respect to the image prior to the combination (the first detection threshold) and the threshold for flaw detection with respect to the combined image (the second detection threshold) become higher, the higher the ISO sensitivity is.

It is assumed that the detection of the flaw is performed on the image prior to the combination and the image after the combination (the combined image) respectively. Since the image prior to the combination does not have a better S/N ratio, it is difficult to detect the flaw pixel in the noise. Therefore, the system control circuit 50 sets the value higher than the threshold for flaw detection with respect to the combined image, as the threshold for flaw detection with respect to the image prior to the combination, so as not to mistakenly detect the noise as the flaw pixel.

Since the combined image has a better S/N, the flaw in the noise can be easily detected. Therefore, the threshold for flaw detection with respect to the combined image is set as a value that is lower than the threshold for flaw detection with respect to the image prior to the combination. Thereby, the smaller flaw can be correctly detected. If the flaw which does not always occur in every shooting, such as the RTS noise flaw, is to be detected, in performing the combination of the images in the addition averaging, the flaw becomes smoothed and small and thereby it is difficult to detect such a flaw. Therefore, prior to the combination, the higher threshold for flaw detection is previously set to be used so as to enable the RTS flaw to be detected. With respect to the image with a better S/N ratio due to the addition averaging, the lower threshold for flaw detection is previously set to be used so as to enable a white flaw when light is always on to be detected. Accordingly, both of RTS flaws and white flaws can be detected with high precision, which improves the quality of the combined image.

FIG. 7 illustrates an exemplary threshold for flaw correction depending on the shutter time.

Since the output level of the flaw is altered by the shutter time, the system control circuit 50 alters the applied threshold for flaw correction depending on the shutter time. Specifically, the threshold for flaw correction is set to be small if the shutter time is short since the level of the flaw is low. If the shutter time is long, the threshold for flaw correction is set to be large since the level of the flaw is high. Also, the value lower than the threshold for flaw detection with respect to the image prior to the combination is set as the threshold for flaw detection with respect to the combined image.

FIG. 8 illustrates the threshold for flaw detection depending on the number of the combined captured images.

While the combination of the images by the addition averaging makes the S/N ratio better and thereby the threshold for detecting the flaw can be reduced, the improvement amount of the S/N ratio that becomes better differs depending on the number of the combined images. Therefore, the system control circuit 50 alters the threshold for flaw detection on the combined image depending on the number of the combined images.

In the example shown in FIG. 8, the system control circuit 50 sets threshold for flaw detection to a lower value the larger the number of the combined images is, by performing the ratio calculation on the threshold for flaw detection with respect to the image prior to the combination (the threshold for flaw detection if the number of the combined images is set to be one).

According to the present embodiment, while the sequence is described without black subtraction, black subtraction may be performed, and furthermore another threshold for flaw detection may be set. Also, if the flaw detection coordinate detected during manufacture is stored, the correction for the flaw may be performed in advance and then, the processing of the detection of flaws by the present embodiment may be performed. Also, since the noise reduction is performed by the combination, the effect of the noise reduction in the processing of the development may be set lower to make the perceived resolution of the image improve. Also, while the description has been given by using the image capture apparatus 100 as the example of the image processing apparatus, this configuration is not intended to limit the present invention. Also, an external device with an image processing function such as a personal computer can receive a plurality of captured images for the combination shot by the image capture apparatus 100, and then perform the processing of the detection of flaws and the processing of the combination. In this case, information about the ISO sensitivity and the shutter time can also be obtained by referring the EXIF data of the plurality of the captured images

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-144405, filed Jul. 22 2016, which is hereby incorporated by reference wherein in its entirety.

What is claimed is:

1. An image processing apparatus, comprising:
circuitry which
combines a plurality of captured images by shooting an object to generate a combined image; and
determines a pixel of interest on the captured images as a correction target pixel if a difference between a signal level of the pixel of interest and a value obtained from the signal level of peripheral pixels is greater than or equal to a threshold,
wherein the circuitry performs the determination on the captured image prior to the combination by using a first threshold, and performs the determination with respect to the combined image by using a second threshold lower than the first threshold, and sets the second threshold with respect to the combined image lower the larger the number of the combined captured images is.

2. The image processing apparatus according to claim 1, wherein the circuitry alters the first threshold and the second threshold depending on a shooting condition in shooting the object.

3. The image processing apparatus according to claim 2, wherein the circuitry sets the first threshold and the second threshold to be higher the higher ISO sensitivity in shooting the object is.

4. The image processing apparatus according to claim 2, wherein the circuitry sets the first threshold and the second threshold to be higher the longer a shutter time in shooting the object is.

5. An image capture apparatus, comprising:
an imaging element which generates a captured image; and
circuitry which
combines a plurality of captured images by shooting an object to generate a combined image; and
determines a pixel of interest on the captured images as a correction target pixel if a difference between a signal level of the pixel of interest and a value obtained from the signal level of peripheral pixels is greater than or equal to a threshold,
wherein the circuitry performs the determination on the captured image prior to the combination by using a first threshold, and performs the determination with respect to the combined image by using a second threshold lower than the first threshold, and sets the second threshold with respect to the combined image lower the larger the number of the combined captured images is.

6. A control method of an image processing apparatus, comprising:
combining a plurality of captured images to generate a combined image; and
determining a pixel of interest on the captured images as a correction target pixel if a difference between a signal level of the pixel of interest and a value obtained from the signal level of the peripheral pixels is greater than or equal to a threshold,
wherein the determination is performed with respect to the captured image prior to the combining by using a first threshold, and the determination is performed with respect to the combined image by using a second threshold lower than the first threshold, and the second threshold with respect to the combined image is set lower the larger the number of the combined captured images is.
